(19) United States
(12) Patent Application Publication
(10) Pub. No.: US 2005/0138814 A1
(43) Pub. Date: Jun. 30, 2005

(54) Shaving apparatus with shaving aid material dispenser

(75) Inventors: Andrew J. Pennella, Stamford, CT (US); Jay Bunnell, Orange, CT (US); Kenneth A. Raymond, Bethany, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/027,338

(22) Filed: Dec. 29, 2004

Related U.S. Application Data
(60) Provisional application No. 60/533,701, filed on Dec. 30, 2003.
(60) Provisional application No. 60/533,700, filed on Dec. 30, 2003.

(51) Int. Cl. B26B 19/44

(52) U.S. Cl. 30/41

(57) ABSTRACT

In a shaving aid material dispenser, a reservoir is provided for storing a shaving aid material therein. A dispenser head is provided and includes a housing having at least one roller rotatably attached to the housing and in fluid communication with the reservoir and its contents. During a shaving operation, as the roller rotates across the surface over which it is being drawn, shaving aid material is distributed from the reservoir to the roller and thereby to the surface being shaved.

### CROSS-REFERENCE TO RELATED APPLICATIONS

This application is entitled to the benefit of and incorporates by reference essential subject matter disclosed in Provisional Patent Application Nos. 60/533,701 filed on Dec. 30, 2003 and 60/533,700 filed on Dec. 30, 2003.

### FIELD OF THE INVENTION

The present invention relates to shaving devices and, is more particularly directed to shaving devices having apparatus for dispensing a flowable shaving aid material.

### BACKGROUND OF THE INVENTION

Conventional safety razors typically include a disposable razor cartridge mounted in a reusable handle, or a handle and cartridge combined into a unitary disposable unit. Most razor cartridges include a frame, at least one razor blade, and a strip of shaving aid attached to the frame. Shaving aid materials include, but are not limited to lubricating agents, drag reducing agents, depilatory agents, cleaning agents, medicinal agents, and the like that enhance the shaving process.

The strip of shaving aid material is typically attached to the razor cartridge adjacent to the razor blade(s). Very often, flowable shaving aid material (e.g., a shaving cream) is also used with the razor assembly. Traditionally, the flowable shaving aid material is applied to the surface to be shaved independent of the shaving process. Applying a uniform layer of non-solid shaving aid material to a surface is not easily done and often creates an undesirable mess.

Based on the foregoing, it is the general object of the present invention to provide a shaving apparatus that is operable to apply a substantially uniform layer of flowable shaving aid material in a desirable manner.

### SUMMARY OF THE INVENTION

According to the present invention, a shaving aid material dispenser includes a reservoir for storing a non-solid shaving aid material and a dispenser head. The dispenser head includes a housing and one or more rollers. Each roller is positioned in an opening in the housing. Each roller is pivotable about an axis and is selectively in fluid communication with the contents of the reservoir. The roller(s) are operable to distribute shaving aid material from the reservoir when rotated.

According to another aspect of the present invention, a shaving apparatus handle includes the shaving aid material dispenser described above mounted on a grip portion.

According to a further aspect of the present invention, a shaving apparatus includes the shaving apparatus handle described above and a razor cartridge having a length, a width, and one or more razor blades. The razor blade cartridge is mounted on the shaving apparatus handle such that the axis about which the roller rotates extends substantially parallel to the length of the razor cartridge.

An advantage of the present invention is that the shaving apparatus of the present invention is operable with a variety of non-solid shaving aid materials, such as, for example, liquids, creams, and gels.

Another advantage of the present invention is that the shaving aid material dispenser does not require the user to operate an independent mechanism to dispense the shaving aid material from the dispensing device.

A further advantage of the present invention is that shaving aid material can be applied from the present invention “on demand”.

The foregoing and other advantages of the present invention will become more apparent in light of the following detailed description of the present invention and accompanying drawings.

### BRIEF DESCRIPTION OF THE DRAWINGS

FIG. 1 is a perspective view of an embodiment of a shaving apparatus incorporating the present invention.

FIG. 2 is a sectional view of the shaving apparatus of FIG. 1 along line 2-2.

FIG. 3 is a sectional view of an embodiment of a shaving aid material dispenser wherein the one or more rollers is an oblate spheroid.

FIG. 4 is a sectional view of an embodiment of a shaving aid material dispenser showing a barrel shaped roller and a reservoir in the form of a flexible pouch.

FIG. 5 is a sectional view of an embodiment of a shaving aid material dispenser having a biasing member shown in the closed position.

FIG. 5A is a sectional view of an embodiment of a shaving aid material dispenser having a biasing member shown in the open position.

FIG. 6 is a sectional view of an embodiment of a shaving aid material dispenser having a slide valve shown in the open position.

FIG. 6A is a sectional view of an embodiment of a shaving aid material dispenser having a slide valve shown in the closed position.

FIG. 7 is a perspective view of a shaving apparatus having a grip portion that includes a razor cartridge support.

FIG. 8 is a perspective view of a shaving apparatus wherein the razor cartridge leads the one or more rollers during shaving.

FIG. 9 is a perspective view of a shaving apparatus wherein the razor cartridge leads at least one of the rollers and trails at least one of the rollers during shaving.

FIG. 10 is a perspective view of a shaving device of the present invention.

FIG. 11 is a perspective view of another embodiment of a shaving aid dispenser in accordance with the present invention.

FIG. 11A is a sectional view along line 11A-11A of FIG. 11 depicting a shaving aid dispenser.

FIG. 12 is a perspective view of an embodiment of the shaving aid dispenser of the present invention having cylindrical rollers.

FIG. 12A is a sectional view along line 12A-12A of FIG. 12.

FIG. 13 is a perspective view of the shaving aid dispenser of the present invention having oblate spheroid rollers.

FIG. 13A is a sectional view along line 13A-13A of FIG. 13.

FIG. 14 is a perspective view of the shaving aid dispenser having rollers of various shapes.

FIG. 15 is a sectional view depicting the shaving aid dispenser with a selectively removable cover.

FIG. 16 is a sectional view depicting the shaving aid dispenser having a selectively removable lid.

### DETAILED DESCRIPTION OF THE PREFERRED EMBODIMENTS

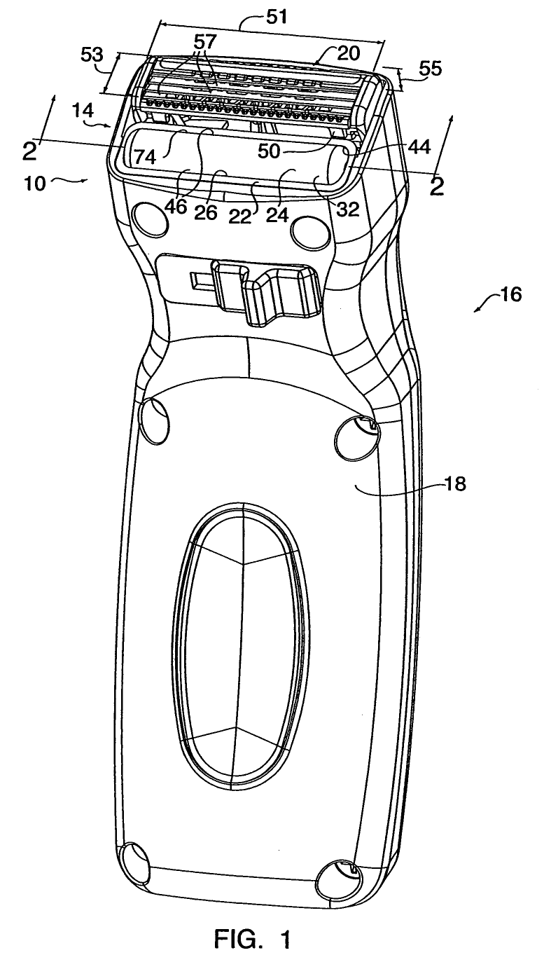

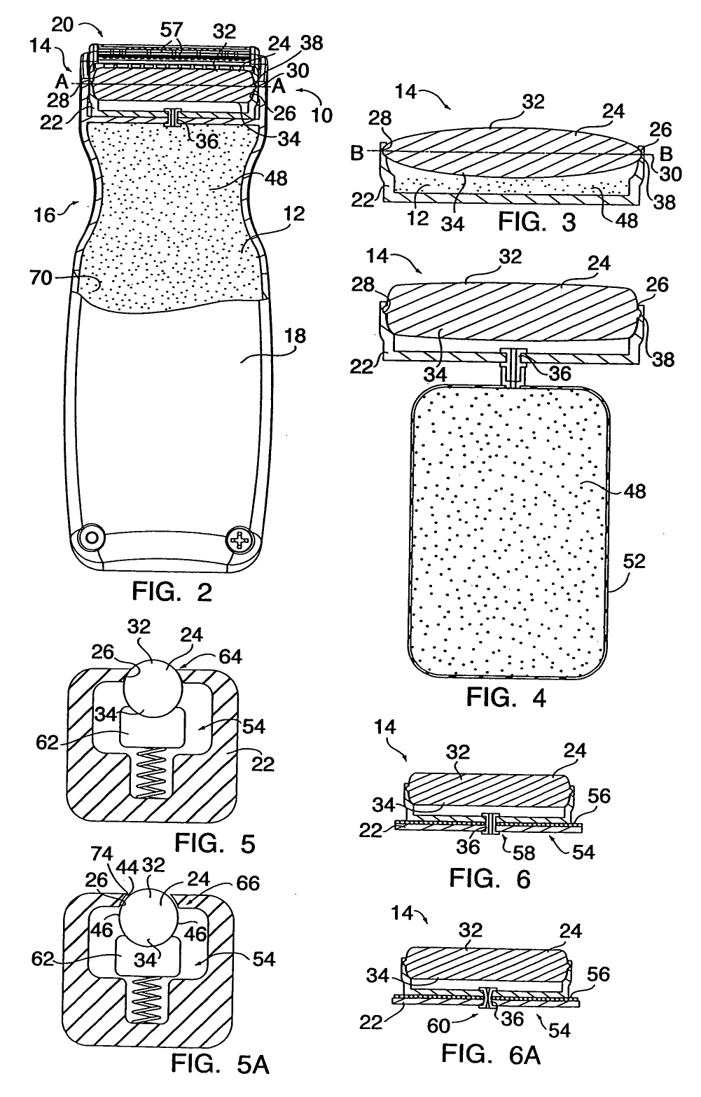

As shown in FIG. 1, a shaving aid material dispenser generally designated by the reference number 10 includes a reservoir 12 (as shown, for example, in FIGS. 2 and 4) and a dispenser head 14. The dispenser head 14 includes a housing 22 and one or more rollers 24. In some embodiments, the shaving aid material dispenser 10 also includes a razor cartridge 20. Although the present invention is discussed primarily herein as a shaving aid material dispenser 10, the embodiment in FIG. 1 shows a shaving apparatus 16 that incorporates the shaving aid material dispenser 10, as well as a grip portion 18. Referring to FIG. 2, each roller 24 is rotatably positioned in an opening 26 in the housing 22. In addition, each opening 26 may include connectors 28 to facilitate rotatably positioning a roller 24 therein.

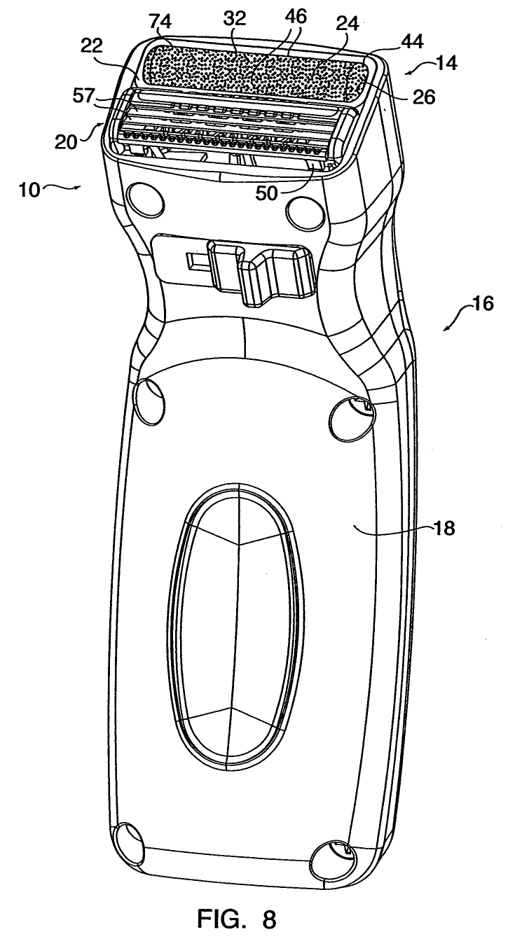

As shown in FIGS. 1-4, the one or more rollers 24 rotate about an axis 30. Each roller 24 may have a smooth surface (as shown in FIG. 1), or a textured surface (as shown in FIG. 8) and may be of any shape that is rotatable about an axis 30. Common roller shapes include, but are not limited to, cylinder (as shown in FIGS. 1 and 2), oblate spheroid (i.e., an ellipse rotated on its polar axis, as shown in FIG. 3), or “barrel” (i.e., an oblate spheroid having flattened ends, as shown in FIG. 4). The cylindrical roller and the oblate spheroid roller shown in FIGS. 2 and 3, respectively, are rotatable around the axes 30 generally indicated by the centerlines “A-A” and “B-B”, respectively.

In the illustrated embodiment, each roller 24 is positioned in an opening 26 such that a portion 32 of each roller 24 extends outwardly from the opening while another portion 34 of each roller is in fluid communication with the reservoir 12, and thereby with the contents contained therein. In some instances, the portion 34 of the roller extends directly into the reservoir 12 (as shown in FIG. 3). In other instances, the portion 34 of the roller 24 is in fluid communication with the reservoir 12 via a fluid inlet 36. The rollers 24 are operable to distribute the flowable shaving aid material 48 from the reservoir when rotated.

Referring to FIGS. 2 and 4, each roller 24 may include connectors 38 to facilitate rotatably positioning the roller 24 in an opening 26. The connectors 38 are typically sized and shaped to compliment the connectors 28 positioned in the opening 26. For example, as shown in FIG. 2, the connectors 38 attached to the roller 24 form a male portion and the connectors 28 in the opening 26 form a female portion. However, numerous styles of complimentary connectors 28,38 may be utilized to facilitate rotatably positioning the one or more rollers 24 within the opening(s) 26.

The one or more rollers 24 are sized such that a gap 44 (as shown, for example, in FIGS. 1, 7 and 8) is defined between each roller 24 and a peripheral surface that at least in part defines the opening 26 in which the roller is positioned. The gap 44 facilitates the passage of a thin layer of flowable shaving aid material 48 therethrough. The actual size of the gap 44 depends on such parameters as the desired flow rate, the viscosity of the shaving aid material 48, and the shape of the rollers 24. In some embodiments, the positions of the roller 24 and the opening 26 relative to one another is fixed. Consequently, the gap 44 therebetween remains constant. In other embodiments, as will be discussed below, the roller 24 is urged into the opening 26, so that the roller and the surfaces defining the opening cooperate to form a valve assembly 54. As a result, the gap 44 is eliminated under certain conditions, and present under others.

Referring back to FIG. 1, in the illustrated embodiment, the dispenser head 14 includes a razor cartridge support 50 for mounting a razor cartridge 20 thereon. The razor cartridge support 50 is positioned on the dispenser head 14 such that the razor cartridge 20 mounted thereon is adjacent the one or more rollers.

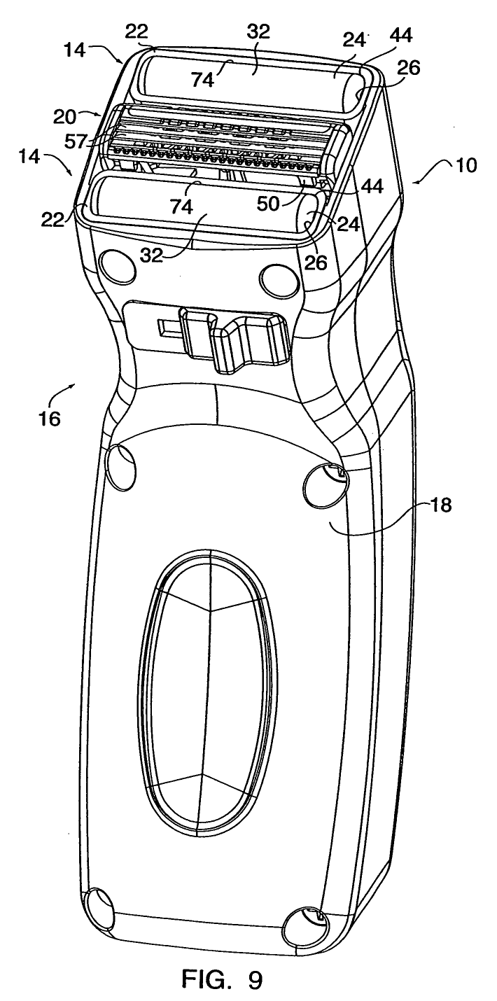

A variety of different razor cartridges 20 can be used with the present shaving apparatus, including those that are intended to be disposable. Therefore, in some embodiments, various different replacement razor cartridges may be used with the present invention. The present invention is not, therefore, limited to any particular type of razor cartridge. Preferably, the razor cartridge 20 is mounted on the shaving aid material dispenser 10 such that the razor cartridge 20 in a longitudinal direction along the length 51 of the razor cartridge is substantially parallel to the axis 30 about which the one or more rollers 24 rotate. As shown in FIG. 1, the razor cartridge 20 is disposed aft of the one or more rollers 24 as those elements would be encountered during a normal shaving stroke. Alternatively, as shown in FIG. 8, the razor cartridge 20 may also be disposed forward of the one or more rollers 24, or rollers 24 can be disposed forward and aft of the razor cartridge 20 as can be seen in FIG. 9.

Referring back to FIGS. 2-4, a flowable shaving aid material 48 is stored in the reservoir 12. As shown in FIG. 4, the reservoir 12 can take the form of a collapsible pouch 52. In alternative embodiments, the reservoir 12 may be formed within the dispenser head 14 (see FIG. 3) or in the grip portion 18 (see FIG. 2). In all embodiments, the reservoir 12 is disposed within the shaving aid material dispenser 10 such that the contents of the reservoir 12 are in fluid communication with the one or more rollers 24. Flowable shaving aid material 48 contained within the reservoir 12 is selectively disposed in contact with the second portion 34 of the one or more rollers 24.

In embodiments where the portion 34 of a roller 24 extends directly into the reservoir 12 (as shown in FIG. 3), the flowable shaving aid material 48 may be in constant contact, or brought into direct contact by tipping the dispensing head 14, with the second portion 34 of the roller 24.

In other embodiments, as shown in FIGS. 2 and 4, the reservoir 12 may be in fluid communication with the second portion 34 of the one or more rollers 24 via a fluid inlet 36 disposed between the rollers 24 and the reservoir 12. The fluid inlet 36 is sized to permit flowable shaving aid material 48 to pass therethrough. The fluid inlet 36 can be sized to advantageously meter flow therethrough. In some embodiments, potential energy devices (not shown) are used to selectively collapse the reservoir 12. Common potential energy devices include, but are not limited to, creep-rollers, pressure pads, and roll-up springs. The potential energy devices are operable to collapse the reservoir 12, thereby forcing the flowable shaving aid material 48 to exit the reservoir, pass through the fluid inlet 36 and contact the second portion 34 of the rollers 24.

Referring to FIGS. 5, 5A, 6 and 6A, the dispenser head 14 can also include a valve assembly 54. The valve assembly 54 is operable to selectively dispense flowable shaving aid material from the dispenser head 14. Typically, the valve assembly 54 is operable to selectively dispense flowable shaving aid material from the reservoir 12 to the one or more rollers 24, or out of the one or more openings 26. Numerous types of valve assemblies 54 may be effectively utilized. The shaving aid material dispenser 10 shown in FIGS. 6 and 6A, for example, may include a slide valve 56. The slide valve 56 is operable to move from an open position 58 to a closed position 60, thereby selectively opening/closing the fluid communication between the second portion 34 of the one or more rollers 24 and the contents of the reservoir 12. In embodiments including a fluid inlet 36, the slide valve 56 may obstruct passage through the fluid inlet 36 by, for example, substantially covering one end of the fluid inlet 36. Or, as shown in FIG. 6A, the slide valve 56, in the closed position 60, may pinch the sides of the fluid inlet 36 shut.

Alternatively, and now referring to FIGS. 5 and 5A, the valve assembly 54 may prevent flowable shaving aid material 48 from exiting the shaving aid material dispenser 10 by selectively closing the gap 44 between the roller(s) 24 and the opening(s) 26. In these embodiments, the valve assembly 54 includes a biasing member 62. For example, each roller 24 can be rotatably positioned between an opening 26 and a biasing member 62. When the biasing member 62 is extended to a closed position 64, the gap 44 between the roller 24 and the opening 26 is eliminated, as shown in FIG. 5. When the biasing member 62 is compressed into an open position 66, (e.g., when the one or more rollers 24 are pressed against the surface being shaved), the gap 44 is created between the roller(s) 24 and the opening(s) 26, as shown in FIG. 5A. In these embodiments, the travel of the roller 24 is limited to a maximum predetermined magnitude. Consequently, the gap 44 can vary between the maximum predetermined magnitude and the closed position 64. The variable gap 44 also permits the flow rate of the shaving aid material 48 to be varied.

As mentioned, a flowable shaving aid material 48 is disposed in the reservoir 12. Flowable shaving aid materials include, but are not limited to, lubricating agents, drag reducing agents, depilatory agents, cleaning agents, medicinal agents, and the like that enhance the shaving process. Common forms of flowable shaving aid materials 48 include liquids, gels and creams.

Referring back to FIG. 1, the shaving apparatus 16 includes the shaving aid material dispenser 10 described above mounted on a handle or grip portion 18. The grip portion 18 may be of any practical shape and size. In some embodiments, the grip portion 18 includes an interior cavity 70 that, for example, receives and conceals the reservoir 12.

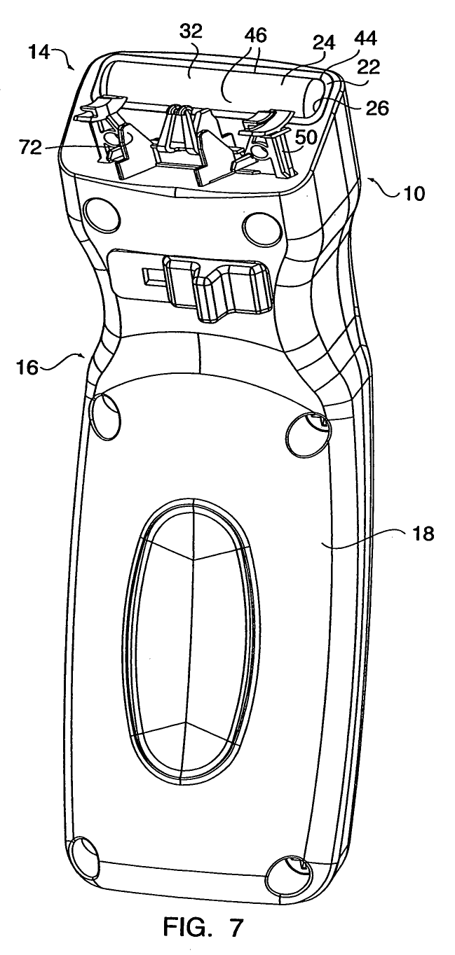

Referring to FIG. 7, in some embodiments, the grip portion 18 also includes a razor cartridge support 72 for mounting a razor cartridge 20 thereon. The razor cartridge support 72 is positioned such that the razor cartridge 20 is adjacent the rollers 24. Preferably, the razor cartridge 20 is parallel in a longitudinal direction corresponding to the cartridge length 51 to the axes 30 about which the rollers 24 rotate when the razor cartridge 20 is mounted on the shaving apparatus 16.

In operation, the portion 34 of the roller 24 is coated with flowable shaving aid stored in the reservoir 12. The user then brings the shaving apparatus 16 in contact with the surface being shaved. As the user moves the shaving apparatus 16, friction between the first portion 32 of the rollers 24 and the surface being shaved causes the one or more rollers 24 to rotate within the housing 22. As the rollers 24 rotate, the flowable shaving aid material 48 is transferred from the reservoir 12, through the gap 44, and to the point of discharge 74. As the flowable shaving aid material 48 reaches the point of discharge 74, the flowable shaving aid material is dispensed on the surface being shaved. Simultaneously, as the shaving apparatus 16 is moved, the razor cartridge 20 shaves the undesired hair from the area being shaved. In those embodiments utilizing valve assemblies 54 consisting of rollers 24 biased into openings 26, the rollers 24 are displaced from the openings 26 when the dispenser head 14 is placed in contact with the surface to be shaved. The displacement creates the gap 44 through which the shaving aid material is dispensed.

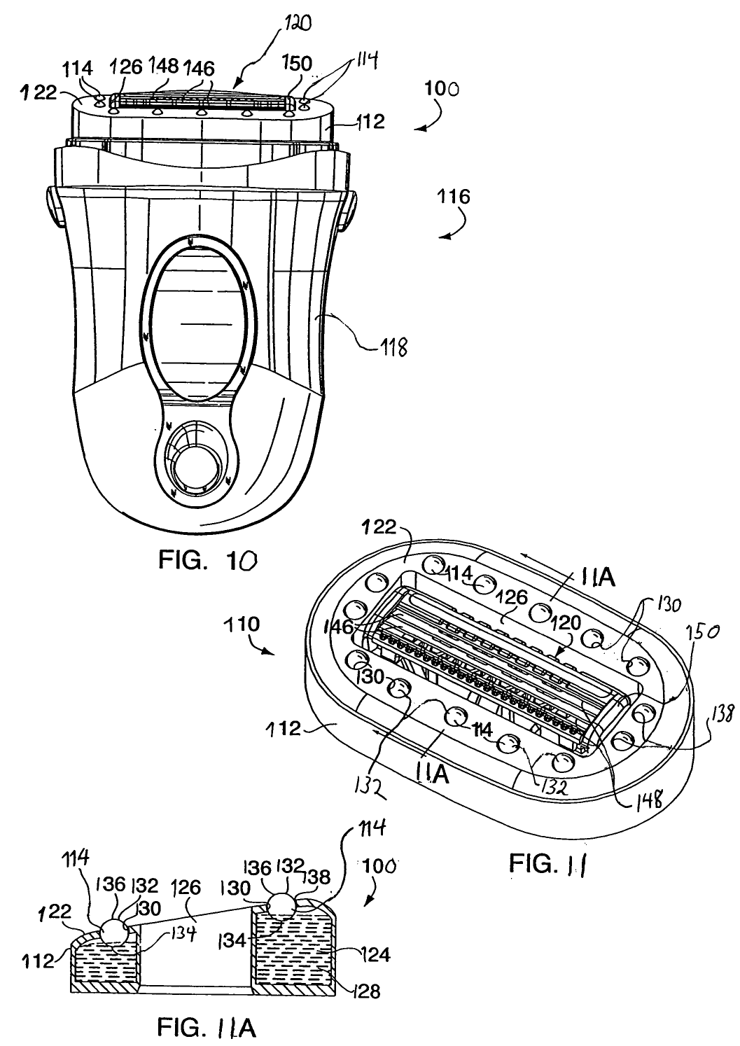

Another embodiment of the shaving aid material dispenser of the present invention is shown in FIGS. 10-16 and is generally designated by the reference number 100. The shaving aid material dispenser 100 includes a dispenser head having a body 112 and a number of rollers 114. In the illustrated embodiment, a shaving device generally designated by the reference number 116 includes the shaving aid material dispenser 100, a handle 118 and a razor cartridge 120.

Referring to FIGS. 11 and 11A, the body 112 includes a contact surface 122 and defines at least one reservoir 124. In the illustrated embodiment, the contact surface defines an aperture 126 extending therethrough. The aperture 126 is adapted to receive the razor cartridge 120 therein. While the body 112 is shown as being oval-shaped, the present invention is not limited in this regard and the body can be any practical shape and size without departing from the broader aspects of the present invention. The contact surface 122 may be substantially smooth or textured. A flowable shaving aid material 128 is disposed in the reservoir 124. Flowable shaving aid materials 128 include, but are not limited to, lubricating agents, drag reducing agents, depilatory agents, cleaning agents, medicinal agents, and the like that enhance the shaving process. The shaving aid material within the reservoir 124 is typically pressurized (e.g., by mechanical means) to force the shaving aid material from the reservoir 124 toward the one or more rollers 114. In some embodiments, the mechanism which is used to pressurize the shaving aid material within the reservoir 124 can be selectively controlled by a switch. A selectively operable switch may also be disposed between the reservoir 124 and the rollers 114.

Continuing to refer to FIGS. 11 and 11A, each of the rollers 114 is rollably positioned in an opening 130 defined by the contact surface 122. A first portion 132 of each roller 114 extends from the contact surface 122 and a second portion 134 of each roller 114 extends into the reservoir 124. The second portion 134 of each roller 114 is in fluid communication with the contents of the reservoir 124. In other words, the second portion 134 of each roller 114 is positioned in, or adjacent the reservoir 124 such that it can be coated by the flowable shaving aid material 128 located in the reservoir. In some embodiments, the shaving aid material dispenser 100 may need to be positioned to cause gravity to cause the flowable shaving aid material 128 in the reservoir 124 to flow into direct contact with the second portion 134 of the roller 114. In other embodiments, the flowable shaving aid material 128 is in constant contact with the second portion 134 of the roller 114. Each of the rollers 114 is operable to deliver the flowable shaving aid material from the reservoir 124 to a point of discharge 136 when the roller 114 is rotated.

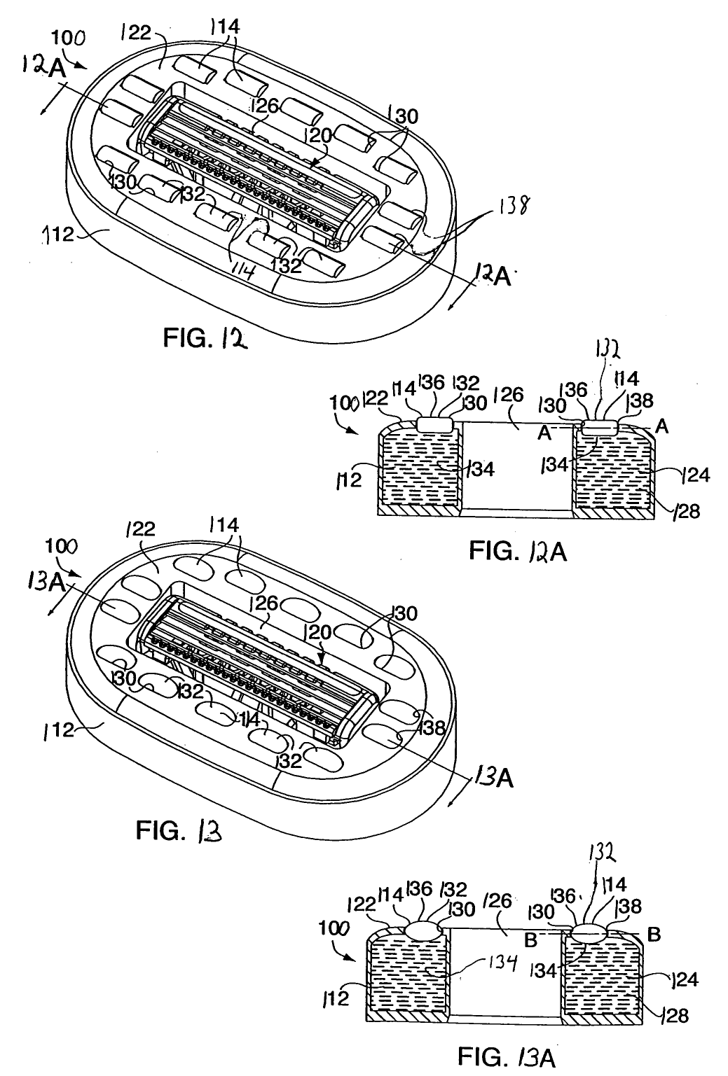

Referring now to FIGS. 11-13, the rollers 114 may be any practical shape, including but not limited to, a sphere (as shown in FIG. 11), a cylinder (as shown in FIGS. 12 and 12A), or an oblate spheroid (i.e., an ellipse rotated on its polar axis, as shown in FIGS. 13 and 13A). In embodiments where the roller 114 is a sphere, the sphere rolls within the opening 130 in any direction, without a fixed axis. In other embodiments, where the roller 114 is not a sphere, the roller 14 rolls on a substantially fixed axis within the opening 130 in the contact surface 122. For example, as shown in FIGS. 12A and 13A, the cylindrical roller 114 and the oblate spheroid roller 114 are rollable substantially around the fixed axes indicated by the centerline “A-A” and “B-B”, respectively. Referring to FIG. 14, the shaving aid material dispenser 100 can have different rollers 114 having various shapes and sizes.

Continuing to refer to FIGS. 11-13, the rollers 114 are sized to roll within the opening 130 defined by the contact surface 122, such that a gap 138 is created between the roller 114 and the opening 130. Conversely, the opening 130 is shaped and sized to maintain the general position of the roller 114 placed therein, while still allowing the roller to rotate. For example, in FIG. 11A, the gap 138 extends substantially around the spherical rollers 114, whereas in FIG. 12, the gap 138 extends substantially along either side 139 of the cylindrical rollers 114. The gap 138 is sized to allow a thin layer of flowable shaving aid material 128 to pass therethrough. The gap 138 may be sized to adjust the rate at which the shaving aid material 128 is dispensed; e.g., to a desired rate for a given flowable shaving aid material 128 viscosity, temperature, and the shape of the roller 114.

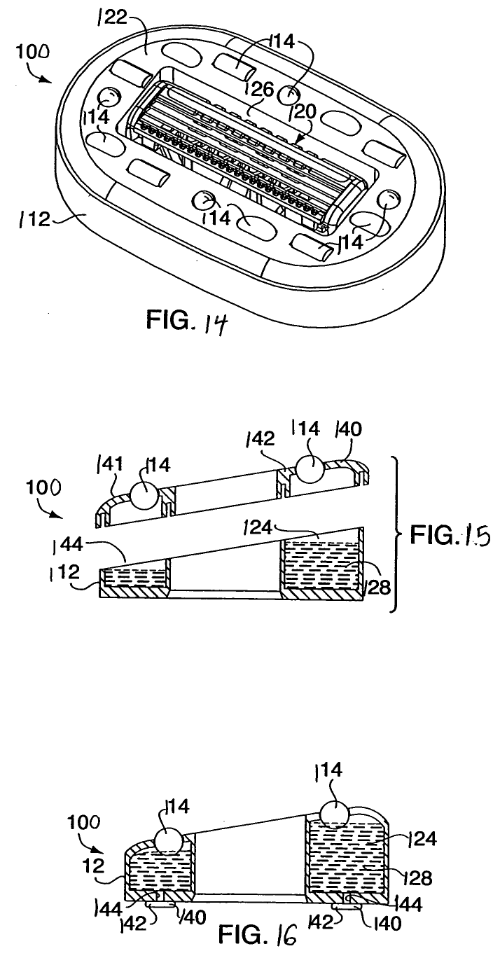

According to another aspect of the invention, and now referring to FIGS. 15 and 16, a portion 140 of the body 112 is selectively removable. For example, as shown in FIG. 15, the top portion 141 of the body 112 is selectively removable to provide access to the reservoir 124. Alternatively, the selectively removable portion 140 can be a removable lid 142. In these embodiments, the body 112 includes a second opening 144 that is substantially covered and sealed, when in place, by the selectively removable lid 142, as shown in FIG. 16. In both embodiments, the selectively removable portion 140 of the body 112 can be removed and additional flowable shaving aid material 128 disposed in the reservoir 124.

Referring back to FIG. 10, the shaving device 116 includes the shaving aid material dispenser 100 described above, the handle 118, and the razor cartridge 120.

Handles 118 used with shaving devices 116 are well known in the art and may be of any practical shape and size. Preferably, the handle 118 is contoured to allow it to be gripped comfortably by the user, as shown in FIG. 10. Typically, the handle 118 is attached to the shaving aid material dispenser 110 such that it is not intended to be removed during normal use. However, the handle 118 may be removably attached to the shaving aid material dispenser 110.

Razor cartridges 120 includes at least one razor blade 146 having a cutting edge 148. The razor cartridge 120 can be fixedly or pivotally attached to the handle 118. A variety of different razor cartridges 120 can be used with the present shaving device 116, including those that are intended to be disposable. The present apparatus is not, therefore, limited to any particular type of razor cartridge 120.

In operation, the shaving device 116 is brought into contact with the surface being shaved. As the shaving device 116 is moved along the surface being shaved, friction between the first rollers 114 and the surface being shaved causes the rollers to roll within the opening 130 in the contact surface 122. The flowable shaving aid material 128 in the reservoir 124 coats the rollers 114. As the rollers roll, the flowable shaving aid material 128 is delivered from the reservoir 124, through the gap 138 between each roller 114 and the opening 130, and to the point of discharge 136. As the shaving aid material 128 reaches the point of discharge 136, the flowable shaving aid material 128 is dispensed on the surface being shaved. Simultaneously, as the shaving device 116 is moved, the cutting edges 148 of the shaving cartridge 120 shave the undesired hair from the area being shaved.

Although this invention has been shown and described with respect to the detailed embodiments thereof, it will be understood by those of skill in the art that various changes may be made and equivalents may be substituted for elements thereof without departing from the scope of the invention.

1. A shaving aid material dispenser, comprising:
a reservoir for storing a flowable shaving aid material therein;
a dispenser head having a housing and at least one roller rotatably attached to the housing and in fluid communication with the contents of the reservoir; and wherein
the at least one roller is operable to distribute the flowable shaving aid material from the reservoir when rotated onto a surface across which the roller is drawn.

2. The shaving aid material dispenser of claim 1, wherein the at least one roller is positioned in an opening defined by the housing.

3. The shaving aid material dispenser of claim 2, wherein the at least one connector is positioned in the roller and the opening in the housing to facilitate rotatably positioning the at least one roller in the opening.

4. The shaving aid material dispenser of claim 2, wherein each of the rollers has an elongated surface of revolution.

5. The shaving aid material dispenser of claim 4, wherein the at least one roller is cylindrically shaped.

6. The shaving aid material dispenser of claim 4, wherein the at least one roller is oblate spheroid shaped.

7. The shaving aid material dispenser of claim 4, wherein the at least one roller is barrel shaped.

8. The shaving aid material dispenser of claim 2, wherein a gap is defined between the roller and a peripheral surface defining the opening.

9. The shaving aid material dispenser of claim 8, wherein the gap between the at least one roller and the peripheral surface is held constant.

10. The shaving aid material dispenser of claim 1 further including a razor cartridge mounted adjacent the at least one roller.

11. The shaving aid material dispenser of claim 10, wherein the razor cartridge longitudinally extends in a direction substantially parallel to at least one axis about which the roller rotates.

12. The shaving aid material dispenser of claim 1 further including a flowable shaving aid material disposed in the reservoir.

13. The shaving aid material dispenser of claim 1 further including a fluid inlet disposed between the one or more rollers and the reservoir, the fluid inlet being sized to permit the passage of flowable shaving aid material there through.

14. The shaving aid material dispenser of claim 1 further including one or more valve assemblies operable to selectively dispense flowable shaving aid material from the dispenser head.

15. The shaving aid material dispenser of claim 14, wherein each of the one or more valve assemblies includes a slide valve operable to move from an open position to a closed position, thereby selectively opening or closing the fluid communication between the one or more rollers and the contents of the reservoir.

16. The shaving aid material dispenser of claim 14, wherein at least one of the valve assemblies includes a biasing member positioned in the opening between one of the rollers and the housing for normally urging the roller away from the housing.

17. The shaving aid material dispenser of claim 16, wherein the roller is biased into the opening when the biasing member is extended to a closed position.

18. The shaving aid material dispenser of claim 16, wherein a gap is disposed between the opening in the housing and the roller when the biasing member is compressed to an open position.

19. The shaving aid material dispenser of claim 1, wherein a portion of the at least one roller extends outwardly from the opening and another portion of the roller is in fluid communication with the reservoir.

20. A shaving apparatus, comprising:
a grip portion having an interior cavity;
a reservoir for storing a flowable shaving aid material, wherein the reservoir at least partially extends into the interior cavity of the grip portion;
a dispenser head including a housing and one or more rollers attached thereto and rotatable about an axis, a first portion of the roller extending outwardly from the dispenser head and another portion of the roller in fluid communication with the reservoir; and
the at least one roller being operable to distribute the flowable shaving aid material from the reservoir when rotated.

21. The shaving apparatus of claim 20, wherein the at least one roller is positioned in an opening in the housing.

22. The shaving apparatus of claim 21, wherein the roller has an elongated surface of revolution.

23. The shaving apparatus of claim 22, wherein the roller is cylindrically shaped.

24. The shaving apparatus of claim 22, wherein the roller is oblate spheroid shaped.

25. The shaving apparatus of claim 22, wherein the roller is barrel shaped.

26. The shaving apparatus of claim 21, wherein a gap is disposed between the rollers and a surface defining the one or more openings.

27. The shaving apparatus of claim 26, wherein the at least one roller and the one or more openings are positionally fixed relative to each other.

28. The shaving apparatus of claim 21 further including a razor cartridge mounted adjacent at least one of the rollers.

29. The shaving apparatus of claim 28, wherein the razor cartridge is substantially parallel to the axis about which at least one of the rollers rotates.

30. The shaving apparatus of claim 20 further including a flowable shaving aid material disposed in the reservoir.

31. The shaving apparatus of claim 20 further including a fluid inlet disposed between the one or more rollers and the reservoir, the fluid inlet sized to permit the passage of flowable shaving aid material there through.

32. The shaving apparatus of claim 20 further including one or more valve assemblies operable to selectively dispense flowable shaving aid material from the dispenser head.

33. The shaving apparatus of claim 32, wherein the one or more valve assemblies includes a slide valve operable to move from an open position to a closed position, thereby selectively opening or closing the fluid communication between the one or more rollers and the contents of the reservoir.

34. The shaving apparatus of claim 33, wherein at least one of the one or more valve assemblies includes one of the rollers rotatably positioned between the opening in the housing and a biasing member.

35. The shaving apparatus of claim 34, wherein the roller of the at least one valve assembly is biased into the opening when the biasing member is extended to a closed position.

36. The shaving apparatus of claim 34, wherein a gap is defined between a peripheral surface at least in part defining the opening and the roller when the biasing member is compressed to an open position.

37. The shaving aid material dispenser of claim 1 wherein:
the dispenser head includes a body having a contact surface, the reservoir being defined by the body; and wherein
the at least one roller is rotatably positioned in an opening defined by the contact surface.

38. The shaving aid material dispenser of claim 37 wherein:
the contact surface, and thereby the dispenser head, defines an aperture extending at least partially there through; and
a razor cartridge including at least one razor blade having an at least partially exposed cutting edge is positioned in the aperture.

39. The shaving aid material dispenser as defined by claim 37 wherein a portion of the at least one roller projects outwardly from the contact surface and another portion of the roller is in fluid communication with the reservoir.

40. The shaving aid material dispenser as defined by claim 37 wherein said body defines a plurality of reservoirs.

41. The shaving aid material dispenser as defined by claim 37 wherein a gap is defined between the at least one roller and a peripheral surface defining, at least in part, the opening in which the roller is positioned, the gap being sized to allow shaving aid material to pass there through.

42. The shaving aid material dispenser as defined by claim 1 wherein the dispenser head is mounted on a handle.

43. The shaving aid material dispenser of claim 1 further comprising a plurality of rollers.

44. The shaving aid dispenser of claim 43 wherein a portion of the plurality of rollers are shaped differently from the remaining rollers.

45. The shaving aid dispenser of claim 37 wherein said reservoir is refillable.

46. The shaving aid dispenser of claim 45 further comprising a selectively removable cover to allow for refilling the reservoir.

47. The shaving aid dispenser of claim 46 wherein said contact surface is part of said cover.
